(19) United States
(12) Patent Application Publication
(10) Pub. No.: US 2026/0131707 A1
(43) Pub. Date: May 14, 2026

(54) SEAT

(71) Applicants: BAYERISCHE MOTOREN WERKE AKTIENGESELLSCHAFT, München (DE); INDORAMA VENTURES MOBILITY OBERNBURG GMBH, Obernburg (DE)

(72) Inventors: Frank LEYMANN, Elsenfeld (DE); Michael NEIDHÖFER, Mainz (DE); Anna GOLDHOFER, München (DE); Leo REDCLIFFE, München (DE)

(73) Assignees: BAYERISCHE MOTOREN WERKE AKTIENGESELLSCHAFT, München (DE); INDORAMA VENTURES MOBILITY OBERNBURG GMBH, Obernburg (DE)

(21) Appl. No.: 19/167,611

(22) PCT Filed: Mar. 14, 2024
(86) PCT No.: PCT/EP2024/056853

§ 371 Date: Sep. 22, 2025

(30) Foreign Application Priority Data
Mar. 24, 2023 (DE) 102023107445.8

(51) Int. Cl. B60N 2/58; B64D 11/06

(52) U.S. Cl. CPC B60N 2/5841; B64D 11/0647

(57) ABSTRACT

The application relates to a seat comprising at least one padding. The padding comprises a first part of a clamping device as well as a three-dimensional network structure with irregularly bound meshes of one or more continuous linear structures. The continuous linear structures are welded together at crossing points and contain at least one thermoplastic elastomer. A first clamping device is formed from the material of the three-dimensional network structure. The application further relates to a method for producing the said seat.

### DESCRIPTION

The application relates to a seat comprising padding.

To make them comfortable, seating furniture has been fitted with padding for centuries, which softens the seat surface, the backrest and/or the armrests and is intended to prevent unpleasant bodily reactions, in particular during prolonged sitting. This is especially true of seating in all kinds of means of transport, which, depending on the occasion, must allow comfortable sitting for hours at a time. In this context, seats in motor vehicles and aircraft are of particular note. In motor vehicles, especially cars, it is decisive that getting up while the vehicle is moving is almost completely impossible and that the seat can therefore only be left when the vehicle itself is left, for example during breaks. In aircraft, it is crucial that, in particular, intercontinental flights can last many hours or take place overnight, so that passengers—especially for sleeping—spend very long periods of time in their seats.

However, the requirement profile for seats in means of transport is not limited to comfort. In aircraft in particular, extremely restrictive weight requirements must be observed.

In addition, there is—especially in recent times—the demand for recyclability. This is not fulfilled for seats whose padding is based on foams such as polyurethane foams (PU foams). Moreover, foam-based padding does not consist of monolithic foam blocks. The seats must contain fastening means that make it possible to attach cover materials to the padding. As a rule, these are wires or clips which are placed in the corresponding molds before foaming and are then embedded in the foam during foam formation.

In addition to poor recyclability, seats based on PU foam have the major disadvantage that their production is exceedingly time-consuming. PU foam is generated in the mold by mixing a polyol component and an isocyanate component with a blowing agent. Isocyanates are, however, highly toxic, and for safe handling of the padding it must therefore be ensured that the reagents have completely reacted by the time the padding is removed from the mold. For this, long dwell times after introducing the reagents are required, which makes production of the padding time-consuming.

These problems are partially solved by replacing PU foams with three-dimensional fiber networks. However, padding made of such three-dimensional fiber networks still contains clips and/or wires made of foreign material, i.e., materials other than the three-dimensional fiber material, which stands in the way of recycling the padding and thus also the seat.

In addition, the padding may contain binders which, for example, hold the fastening means such as clips and/or wires in position and likewise hinder recycling.

It is the object of the invention to provide a comfortable, lightweight and readily recyclable seat that is suitable for all types of means of transport.

The object is achieved by a seat comprising at least one padding, the padding comprising a first part of a clamping device as well as a three-dimensional network structure comprising irregularly bound meshes of one or more continuous linear structures, which continuous linear structures are welded to one another at crossing points, the continuous linear structures containing at least one thermoplastic elastomer, characterized in that the first part of the clamping device is formed by the material of the three-dimensional network structure.

A “seat” within the meaning of the present application is a piece of furniture essentially intended for people to sit on. Such items of furniture are generally known, and in particular also to the person skilled in the art, under various terms. A seat within the meaning of the present application therefore encompasses all types of seating furniture, but in particular those known as stools, footstools, chairs, armchairs, thrones, sofas, couches, benches or récamières. Among these types of seating furniture, items are usually understood as furnishings for living or working spaces; however, seats explicitly also include those intended for the accommodation of passengers in individual or public means of transport, such as seats in cars, buses or other road vehicles, seats in rail vehicles, seats in aircraft or on ships, in particular on ferries.

Seats in means of transport, but also many seats serving as furnishings, usually have padding.

“Padding” within the meaning of the present application is understood to be compliant, elastic bodies that are connected to a seat and serve to increase seating comfort by cushioning excessive forces on the buttocks, back, thighs or other body parts of the seated person. In particular, prolonged sitting—for example in means of transport—is made significantly easier by padding of the seats provided for this purpose.

A “clamping device” within the meaning of the present application is a fastening means consisting of at least two parts. One part of the clamping device is designed to exert force on another part in such a way that the first and the second part enter into a detachable mechanical connection, which may be a force-locking or form-locking connection, or a combination thereof.

In one embodiment, one part of the clamping device may be a clamp. The clamp may, for example, consist of two hooks that are located a short distance from each other and are designed such that they exhibit a certain degree of flexibility relative to one another.

The other part may then be a pin which can be grasped or embraced by the clamp. The pin may, for example, be a pin with a surface texturing such as a groove.

In one embodiment, the pin is inserted between the hooks of the clamp, the hooks of the clamp moving apart upon insertion and returning to their original position when they engage into the surface texturing of the pin. In this way, the pin is grasped by the clamp and is detachably connected to it, separation of the connection requiring greater force than closing the connection. Closing the connection is known to the skilled person for the described form as “snap-in”.

The first part of the clamping device located on the padding within the meaning of the present application may be any part of a clamping device. Accordingly, in one embodiment the first part of the clamping device may be a clamp; in another embodiment the first part of the clamping device may be a pin.

In one embodiment, the first part of the clamping device is capable of exerting a force of not less than 70 N on a second part of the clamping device in contact with it. Accordingly, the force necessary to separate the two parts of the clamping device is not less than 70 N.

The padding according to the present application has a three-dimensional network structure comprising irregularly bound meshes of one or more continuous linear structures. The continuous linear structures are welded to one another at crossing points.

Continuous linear structures within the meaning of the present application may be, for example, threads, yarns, fibers or filaments. A filament is understood to be a single fiber whose length, compared to its thickness, is practically infinite. Individual filaments, at a thickness of a fraction of a millimeter, may have a length of one meter or more. The length of a filament may even be one kilometer or more.

“Threads” or “yarns” are structures consisting of more than one fiber or more than one filament, the fibers or filaments being connected to one another by twisting, swirling, bonding or welding in such a way that they can be handled jointly, i.e., produced, wound, transported and processed together as a fiber bundle. Threads and yarns may contain both filaments and shorter fibers, i.e., fibers with a length of less than one meter, which are then formed into a thread or yarn by twisting, for example.

The network structure of the padding is formed by irregularly bound meshes of the continuous linear structure(s), the continuous linear structure(s) being laid into meshes in such a way that they form a three-dimensional structure which is held in shape by punctual welds at crossing points. In one embodiment, this is a self-supporting structure which can be compressed by the action of an external force and which develops internal stresses upon compression. These internal stresses ensure that the three-dimensional network structure springs back into its original shape after the force ceases.

In one embodiment, the three-dimensional network structure forms an elastic, spring-acting random-fiber mat.

It is important to emphasize that in a three-dimensional network structure according to the present application, empty space—i.e., air or another gas—exists between the continuous linear structures, as the term “meshes” for the interstices already implies.

In one embodiment, the meshes of the three-dimensional network structure—disregarding impurities—are free of solid substances such as foams or binders.

The elastic properties attributed to the three-dimensional network structure within the meaning of the present application do not in any way imply that the three-dimensional network structure must contain classical elastomers. Rather, the three-dimensional network structure may be free of classical elastomers.

Classical elastomers, which consist of weakly crosslinked macromolecules, must be distinguished from thermoplastic elastomers.

The continuous linear structure according to the present application contains at least one thermoplastic elastomer. Thermoplastic elastomers are high-molecular compounds (“polymers”) which exhibit elastic properties at a temperature of 298 K but are thermally deformable at higher temperatures like thermoplastics. In contrast to classical elastomers such as rubber, which are composed of slightly crosslinked macromolecules, thermoplastic elastomers consist of non-crosslinked, chain-like macromolecules and—unlike classical elastomers—can be made deformable and molten by the application of heat without chemical decomposition. This makes it possible to recycle thermoplastic elastomers like classical thermoplastics, which is not possible with classical elastomers.

Typical thermoplastic elastomers belong to the well-known families of thermoplastic polymers, such as polyamides or polyesters. In general, polyamides are polymers formed by the formation of amide groups between amino groups and carboxylic acid groups of their monomers. The simplest polyamides are formed either by polymerizing a dicarboxylic acid and a diamine—such as adipic acid and hexamethylenediamine, which together form polyamide-6,6—or by polymerizing an aminocarboxylic acid or a lactam—such as ε-caprolactam, which polymerizes to polyamide-6. Polyamides consisting of a dicarboxylic acid and a diamine or of a lactam or an aminocarboxylic acid do not, however, exhibit elastomeric properties. For this, the involvement of additional monomers is necessary, which are incorporated into the macromolecules during polymer build-up and prevent the formation of overly large, regular and thus crystalline regions of aggregated polymers. Rather, thermoplastic elastomers have smaller crystalline regions in which adjacent macromolecules are connected to one another by non-chemically bonding interactions in such a way that the “crosslinking” can be dissolved by the application of heat and re-formed upon cooling. The formation of such weak interactions is possible in copolymers whose chains contain more different monomers than are strictly necessary for chain formation. In the case of the aforementioned polyamides, for example, a thermoplastic elastomer can be built up from a dicarboxylic acid and two or more different diamines or from two or more different dicarboxylic acids and one diamine. A build-up from two or more different aminocarboxylic acids or two or more different lactams is also possible.

The simplest polyesters are formed by polymerizing a dicarboxylic acid with a diol. By this route, for example, ethylene glycol and terephthalic acid form polyethylene terephthalate (PET). Polymerization of a hydroxycarboxylic acid or a lactone is also possible. By this route, for example, lactic acid forms polylactide (PLA) or caprolactone forms polycaprolactone. Polyesters built up only from one dicarboxylic acid and one diol or from one hydroxycarboxylic acid or a lactone do not exhibit elastomeric properties. To achieve elastomeric properties here as well—as with the aforementioned polyamides—the number of monomers must be increased so that two or more dicarboxylic acids and/or two or more diols are used. The use of two or more hydroxycarboxylic acids or two or more lactones is also possible.

Thermoplastic elastomers based on polyesters are typically divided into two classes, polyester-ester block copolymers and polyester-ether block copolymers.

Both groups have in common that they possess “hard” and “soft” chain segments.

In thermoplastic elastomers of the polyester-ester block copolymer group, both the hard and the soft chain segments are formed from polyester units.

As dicarboxylic acids for both the hard and the soft chain segments, aromatic carboxylic acids such as terephthalic acid, isophthalic acid, naphthalene-2,6-dicarboxylic acid, naphthalene-2,7-dicarboxylic acid and diphenyl-4,4′-dicarboxylic acid come into consideration, as do alicyclic carboxylic acids such as 1,4-cyclohexanedicarboxylic acid and aliphatic dicarboxylic acids such as succinic acid, adipic acid, sebacic acid and fatty acid dimers (“dimer acids”). Derivatives of the carboxylic acids mentioned, such as carboxylic anhydrides or carboxylic halides, can each also be used.

For the diol component, for the “hard” chain segments, aliphatic diols such as 1,4-butanediol, ethylene glycol, trimethylene glycol, pentamethylene glycol, hexamethylene glycol, and alicyclic diols such as 1,1-cyclohexanedimethanol and 1,4-cyclohexanedimethanol may be used. Ester-forming derivatives of these diols, such as the corresponding chloro-, bromo-or iodoalkanes, may likewise be used.

Furthermore, so-called polyester diols can be used. These are oligomers or polymers which, like polyesters, are built up from dicarboxylic acids and diols, from hydroxycarboxylic acids or from lactones, but in which both chain ends are ensured to contain hydroxy groups and which therefore insert like diol units into polyester chains. Polyester diols may include polylactones such as polycaprolactone which are modified by reaction with a diol or a precursor thereof such as a haloalkanol such that both chain ends exhibit hydroxy groups. Polyester diols typically have an average molar mass of 300 to 5000 g/mol. As a rule, aliphatic polyesters underlie polyester diols.

Embodiments of polyester-ester block copolymers are, for example, triblock copolymers containing terephthalic acid and/or naphthalene-2,6-dicarboxylic acid as the dicarboxylic acid, 1,4-butanediol as the diol component, and polylactone as the polyester diol.

Polyester-ether copolymers can be based on the same dicarboxylic acids and diols as polyester-ester copolymers. In addition, the basis may also be a polymerized hydroxycarboxylic acid or a polymerized lactone. However, instead of a polyester diol component, polyester-ether copolymers contain a polyether diol component as the “soft” chain segment. The polyether diol component may, for example, be polyalkylene glycols such as polyethylene glycol, polypropylene glycol, polytetramethylene glycol, as well as ethylene oxide-propylene oxide copolymers. The average molar mass of the polyether diol component can be between 300 and 5000 g/mol.

In one embodiment, the three-dimensional network structure consists of a thermoplastic elastomer.

The first part of the clamping device is formed from the material of the three-dimensional network structure. For this purpose, part of the three-dimensional network structure is plastically deformed after its formation in such a way that the first part of the clamping device is formed. In one embodiment, the plastic deformation is accompanied by an increase in the density of the three-dimensional network structure in a limited region. In one embodiment, the first part of the clamping device exhibits aggregated linear structures of the three-dimensional network structure which are no longer welded together only at crossing points but are welded together over a greater length or remelted into a new form. As a result, the first part of the clamping device has a significantly stiffer constitution than the surrounding part of the padding.

The first part of the clamping device formed in this way from the material of the three-dimensional network structure may consist visibly of fused and/or bonded linear structures which give it the appearance of a shape consisting of aggregated threads. However, the first part of the clamping device may also have completely smooth contours if the continuous linear structures are completely melted during its formation and thereby brought into a new form.

Shaping the first part of the clamping device out of the three-dimensional network structure can be carried out, for example, by a thermoforming process in which the three-dimensional network structure as a whole or locally is heated to a temperature at which it becomes plastically deformable or liquefies. A part of the plastically deformable and/or liquefied network structure can then be shaped by grasping or embracing with a corresponding forming tool which may, for example, have the shape of pliers. Methods such as hot riveting and/or hot stamping, welding or soldering may also be used for this purpose.

In one embodiment, shaping the first part of the clamping device is performed exclusively using the already present material of the three-dimensional network structure. That is, no additional material is introduced into the three-dimensional network structure during shaping of the first part of the clamping device.

By virtue of its creation, the first part of the clamping device is inseparably connected to the network structure of the padding. “Inseparable” within the meaning of the present application means that it is not possible to separate the connection without cutting material and thereby at least partially destroying the network structure. The inseparable connection is produced by material bonding.

Because the first part of the clamping device is formed from the material of the three-dimensional network structure, it is ensured that the three-dimensional network structure and the first part of the clamping device consist of the same material and therefore need not be separated from one another for recycling. Such structures are known to the skilled person under the term “monomaterial”.

Polymers can be recycled, for example, by depolymerization processes in which the polymers are cleaved into their monomers and the monomer mixture obtained is separated, e.g. by distillation, and made available for further use. Because the recovered monomers can be very well purified in depolymerization processes, polymers of particularly good quality can be produced from them very easily.

However, depolymerization processes are comparatively complex from both a process-engineering and economic perspective.

It is significantly simpler to directly melt the item to be recycled—if necessary after coarse or finer comminution—and reshape it into new products made of the same polymer, optionally with further production steps prior to reshaping for cleaning or other quality improvements such as crystallization or post-condensation steps. The skilled person refers to this case as “direct recycling”. Direct recycling processes are associated with significantly less effort than depolymerization processes, but in order to deliver products of good quality, they require a high purity of the material used, which is particularly the case when products that are homogeneous and consist of a single material are used, as may be possible, depending on the embodiment, with the padding according to the present application.

In one embodiment, the padding has channels in which the first parts of the clamping device are located. These channels, known to the skilled person as “filing channels”, are generally incisions in the padding that are so narrow that their deepest point is only visible when the padding is pulled apart by mechanical loading.

The function of the channels is to conceal the first part of the clamping device in such a way that the clamping device—which may be harder than the padding—cannot be felt by the person sitting on the padding and thus does not impair seating comfort. In one embodiment, the thickness of the padding is at least 60 cm.

To fulfill this function, the channels must have a sufficient depth, the depth of the channels also being matched to the deformability of the network structure of the padding. For seat padding of the prior art made of polyurethane foam, methods according to standards DIN EN ISO 3386-1 for compression hardness in kPa, DIN EIN SO 845 for bulk density in kg/m³ and EIN 53579 for indentation hardness in N are used to determine deformability. Different portions of the seats exhibit different parameters measured according to these standards. Thus, for the main surfaces of the backrest, the compression hardness is 4-7 kPa and the indentation hardness is 125-250 N. For the backrest bulge surfaces, the compression hardness is 8-14 kPa and the indentation hardness is 160-300 N.

Moreover, the depth of the channels can be chosen such that not only the first but also a second part of the clamping device, which is connected to the first part of the clamping device, can no longer be felt by a person sitting on the padding. In this way, the channels serve to fasten, for example, cover material to the padding.

In one embodiment, the channels can be produced by a thermoforming process. The thermoforming process may consist solely in providing an otherwise manufactured network structure with channels. However, the thermoforming process may also serve to reshape a manufactured network structure as a whole and at the same time provide it with channels.

The formation of the first part of the clamping device can also be integrated into the thermoforming process for forming the filing channels and/or for reshaping the three-dimensional network structure as a whole.

The network structure may be present, for example, in the form of cuboids, blocks, T-profiles, I-beams (double-T-profiles) or other shapes. By thermoforming, these network structures can be brought into a different form as required for use as padding. Rounding of corners and edges may play a role here as well as forming, for example, a seat depression adapted to the shape of the buttocks.

Thermoforming can be carried out with appropriate forming tools. Typical forming tools consist of two or more parts which, in the course of the forming process, are connected together so that they enclose a cavity, the shape of which corresponds to the shape into which the network structure is to be brought. The external shape—such as corners, edges or depressions—is specified by the outer walls of the forming tool. The channels are produced by thin plates on the inside of the forming tool, known to the skilled person as “blades”.

For forming the first part of the clamping device, the forming tool can additionally have elements which, for example by grasping a part of the three-dimensional network structure, are able to form the first part of the clamping device. Suitable elements can be in the form of pliers whose limbs in the open state embrace a part of the three-dimensional network structure. Upon closing the limbs, the material thus grasped is densified and, where appropriate, plastically deformed by the action of heat in such a way that the first part of the clamping device is formed. In densifying and deforming a part of the three-dimensional network into the first part of the clamping device, however, it must be ensured that the first part of the clamping device is in no case separated from the remainder of the three-dimensional network and that its connection to the remainder of the three-dimensional network is not weakened in such a way that the first part of the clamping device tears out under normal loading, such as occurs when clipping a seat padding. In one embodiment, this loading is 70 N.

For thermoforming, a network structure is provided and heated to a temperature at which the network structure becomes plastically deformable but does not yet liquefy. The forming tool is then closed around the heated network structure, and the network structure is cooled in the mold to a temperature at which it is no longer deformable. The forming tool is then opened and the thermoformed network structure is removed from the forming tool. To facilitate removal from the forming tool, it may be necessary to treat the forming tool with suitable release agents, such as silicone oils, prior to thermoforming. Water-based release agents can also be used. These may be, for example, dispersions of hydrocarbons with 12-15 carbon atoms in water or dispersions of hydrocarbons with 11-13 carbon atoms in water, or combinations thereof. Surfactants are typically used in such aqueous dispersions to keep them stable. For this, for example, so-called fatty amines such as tallow amine can be used. Organo-tin compounds such as dimethylbis[(1-oxoneodecyl)oxy]stannane can also be used as release agents or be admixed with other release agents. Alternatively, it is also possible to provide the inner surfaces of the forming tool with a non-stick coating. Suitable coatings, which must withstand the temperatures of the thermoforming process, are known to the skilled person. One possible material is, for example, polytetrafluoroethylene.

Forming the first part of the clamping device according to the present application can be carried out together with other thermoforming processes or by a separate process independent of other processing steps.

In one embodiment, the seat has a cover material. The cover material contains a second part of the clamping device and is connected to the padding by bringing the first part of the clamping device into contact with the second part of the clamping device.

The function of the cover material is to cover the open surface of the padding and thus, for example, to protect it against the ingress of dust, dirt and vermin. In addition, it can cover the surface of the padding in a visually and/or haptically pleasing manner and is also amenable to design. By choosing the cover material, the seat according to the invention can be styled accordingly and thus, for example in seats in aircraft or rail vehicles, adapted to the operator's corporate identity.

The cover material can be made of all materials that meet the requirements in terms of appearance and haptics. Both textile materials such as velour, plush or simple woven fabrics are conceivable, which can consist of natural fibers such as cotton as well as man-made fibers such as viscose or lyocell, or of synthetic fibers such as polyester, polyamide or polyacrylonitrile. In addition, leather and artificial leather are also conceivable as cover materials. Artificial leather usually consists of fabrics coated with polymers such as polyvinyl chloride or polyurethane, or of polymer films, for example made of polyurethane.

If the padding has channels and the first part of the clamping device is located in the channels, the cover material is pushed into the channels for fastening to the padding and the second part of the clamping device is connected to the first part of the clamping device. As a result, the cover material has a fold whose depth corresponds to the depth of the channel. Such folds are known to the skilled person under the term “filing flap”. To prevent the ingress and accumulation of dirt, dust and vermin in this fold, the fold can be closed by sewing on a welt or a piping. This also helps to make the seat appear visually more homogeneous.

In one embodiment, the connection between the first part of the clamping device and the second part of the clamping device is a detachable connection. Detachable connections can be separated by a certain amount of force or a particular type of movement, and the two parts of the clamping device can be separated from each other again without destruction. The clamping devices should be designed such that separating the first and second parts can be accomplished technically as simply as possible and without special equipment when, for example, cover materials are to be replaced and/or removed for recycling.

In one embodiment, the pull-out force required to detach the cover material from the padding is not less than 70 N.

In one embodiment, the cover material and the second part of the clamping device contain a polymer from the same polymer family as the three-dimensional network structure. Thus, if the three-dimensional network structure contains a thermoplastic elastomer based on polyester such as a polyester-ether copolymer or a polyester-ester copolymer, the cover material likewise contains a polymer from the polyester family, such as polyethylene terephthalate, polybutylene terephthalate or polytrimethylene terephthalate.

In one embodiment, the cover material and the second part of the clamping device consist of the same polymer as the three-dimensional network structure and the first part of the clamping device. In this way, the seat according to the application can be recycled very readily as a whole.

In one embodiment, the linear structures forming the network structure are wholly or partially hollow. Hollow linear structures have the shape of tubes or hoses and are characterized by a particularly low specific weight, which is of particular interest for use in seats in means of transport such as cars, rail vehicles or aircraft. In addition, hollow linear structures provide the possibility of filling the same volume with a lower material input.

Hollow linear structures can be combined with solid—i.e., non-hollow—linear structures in all ways known to the skilled person when building the network structure. It is possible, for example, for hollow and solid linear structures to form different, separate or merging layers within the network structure. In one embodiment, for example, the inner region of the network structure contains hollow linear structures and is covered by a thin layer of solid linear structures which forms the termination and, for example, establishes contact to a cover material. The layer of solid linear structures can also have a higher density than the areas below and thus increase the seating comfort of the padding and hence of the seat.

In one embodiment, the linear structures forming the three-dimensional network structure have not less than 200 bonding points per gram of the three-dimensional network structure.

The bonding points of the linear structures laid into meshes ensure the cohesion and three-dimensional build-up of the network structure. Their number per mass unit of the network structure is crucial for its compressibility and the ability to spring back into its original shape after compression. The number of bonding points is therefore important for the perceived “hardness” or “softness” of the padding and of the entire seat and thus for the seating comfort of the seat according to the present application. In one embodiment, the number of bonding points is not less than 500 per gram of the network structure.

In one embodiment, the fineness of the linear structures forming the three-dimensional network structure is not less than 100 dtex and not more than 60000 dtex. One dtex means that 10 kilometers of the corresponding linear structure have a mass of one gram. At a fineness of 100 dtex, the mass of 10 kilometers of the linear structure is therefore 100 grams.

In one embodiment, the fineness of the linear structure is not less than 200 dtex and not more than 10000 dtex.

The fineness of the linear structure plays a role in the haptic impression of the padding. The finer the linear structures are, the more likely the haptics of a homogeneous structure are obtained. Linear structures of lower fineness lead to a coarser appearance of the network structure, which feels less pleasant to the touch and may subject a cover material to greater mechanical stress.

In one embodiment, the diameter of the linear structure is not less than 0.1 mm and not more than 1.5 mm. The diameter of the linear structure affects the haptics of the padding in a similar way to fineness, but it is important to emphasize that the diameter and fineness of the linear structure are not directly correlated. This is, first, because in determining fineness, in addition to the diameter of the linear structure, the specific weight of the material of the linear structure also plays a role; and second, because the linear structure does not have to be homogeneous over its entire diameter but can be, for example, hollow.

In one embodiment, the network structure has a raw density of not less than 5 kg/m³ and not more than 200 kg/m³. The raw density is the density of the network structure as produced and before it has been subjected to any shaping processes such as thermoforming. The lower the raw density of the network structure, the lower the weight of the padding containing it and thus of the seat containing it.

In one embodiment, the seat as a whole according to the present application or the padding contained in the seat according to the present application can be recycled as a whole. In principle, several processes are available for the recycling of polymer waste, but these only deliver a usable product if only products made of the same polymer or at least of the same polymer family are recycled simultaneously in these processes. Especially for the polymer families of polyesters and polyamides, for example, depolymerization processes are used in which the polymer chains are wholly or partially cleaved into their monomers, the monomers are separated and purified and subsequently repolymerized, producing a product that is practically indistinguishable from non-recycled material. However, this is offset by a comparatively high economic and equipment outlay.

Processes in which a polymer is melted, optionally post-treated and then reshaped into new products are significantly simpler to carry out. However, such melting processes can only be realized with goods that are entirely made of the same—or at least extremely similar—polymers.

The application further relates to a method for forming a first part of a clamping device on a padding, the padding comprising a three-dimensional network structure comprising irregularly bound meshes of one or more continuous linear structures, which continuous linear structures are welded together at crossing points, the continuous linear structures containing at least one thermoplastic elastomer, characterized in that the first part of the clamping device is shaped, in a thermoforming process, from the material of the three-dimensional network structure using a part of the three-dimensional network structure.

The thermoforming process for forming the first part of the clamping device can be combined with other shaping processes as used in the production of the padding. However, the first part of the clamping device can also be produced in an independent thermoforming process. For a thermoforming process to form the first part of the clamping device, it is necessary to heat the padding or a part thereof to a temperature at which the three-dimensional network structure of the padding becomes thermally deformable, softens or begins to liquefy. Heating can be carried out in various ways known to the skilled person. The use of hot air or radiant heaters is conceivable, for example. Since the three-dimensional network structure is a body of very low density, it is possible to place means for local heating at the location within the three-dimensional network structure that is to be thermally reshaped. For example, pipelines that supply hot air or rod-or lance-shaped infrared lamps or radiant heaters are conceivable, which heat the network structure in their immediate vicinity and thus make it plastically deformable.

The actual process of thermoforming is carried out with a forming tool that has at least two elements which together enclose a cavity having the shape of the first part of the clamping device to be formed. It is important that the cavity is not closed in such a way that the continuous linear structures forming the three-dimensional network structure are severed, but that, on the contrary, the first part of the clamping device formed by the thermoforming process remains connected to the three-dimensional network structure.

Forming the first part of the clamping device can be combined with other forming processes during production of the padding, for example with the formation of filing channels. Material that is displaced by plastic deformation in order to produce the channel can be reshaped into the first part of the clamping device using a suitable forming tool. In one embodiment, it can then be realized that the first part of the clamping device comes to lie in the interior of the filing channel, which is particularly advantageous for fastening cover material to the first part of the clamping device.

### FIGURES DESCRIPTION

The figures show embodiments of the subject-matter of the application. They are not to be interpreted as restricting the subject-matter of the present application in any way.

FIG. 1 shows a schematic representation of a first clamping device 2 that has been formed by compressing and heating the three-dimensional network structure 1 made of a linear structure 4. The three-dimensional network structure has an A-side (front) and a B-side (rear). The first clamping device 2 is shaped in such a way that a second clamping device 3 can engage into it. The connection of the first and the second clamping device is so strong that it can withstand a tensile force (arrow).

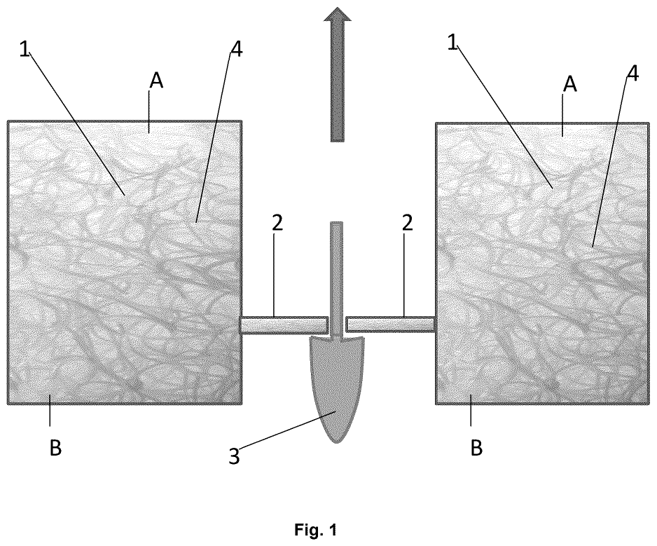

FIG. 2 shows photos of the first part of the clamping device from FIG. 1 from the A-side (front) and the B-side (rear) of the three-dimensional network structure. It is clearly recognizable that the first clamping device has been formed by welding linear structures 4.

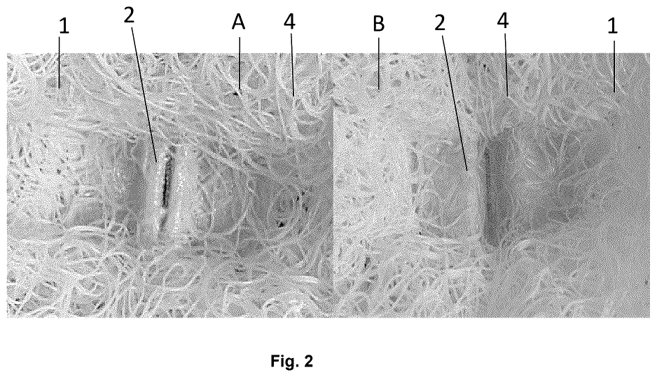

1. Seat comprising
at least one padding, the padding comprising
a first part of a clamping device, and
a three-dimensional network structure comprising irregularly bound meshes of one or more continuous linear structures, which continuous linear structures are welded to one another at crossing points, the continuous linear structures containing at least one thermoplastic elastomer,
characterized in that
the first part of the clamping device is formed by the material of the three-dimensional network structure.

2. Seat according to claim 1, wherein the padding has channels in which the first parts of the clamping device are located and wherein the channels are preferably produced by a thermoforming process.

3. Seat according to claim 1 or 2, additionally comprising a cover material, the cover material comprising a second part of the clamping device, wherein the cover material is connected to the padding by bringing the first part of the clamping device into contact with the second part of the clamping device, preferably in a detachable manner.

4. Seat according to one or more of the preceding claims, wherein the linear structures forming the padding are wholly or partially hollow.

5. Seat according to one or more of the preceding claims, wherein the three-dimensional network structure has not less than 200 bonding points, preferably not less than 500 bonding points per gram of the network structure.

6. Seat according to one or more of the preceding claims, wherein the continuous linear structure has a fineness of not less than 100 dtex and not more than 60000 dtex, preferably not less than 200 dtex and not more than 10000 dtex.

7. Seat according to one or more of the preceding claims, wherein the continuous linear structure has a diameter of not less than 0.1 mm and not more than 1.5 mm.

8. Seat according to one or more of the preceding claims, wherein the network structure has a raw density of 5 to 200 kg/m³.

9. Seat according to one or more of the preceding claims, wherein the thermoplastic elastomer is a thermoplastic elastomer based on polyester, preferably a polyester-ester copolymer or a polyester-ether copolymer, and wherein the network structure particularly preferably consists of this thermoplastic elastomer.

10. Seat according to one or more of the preceding claims, wherein the cover material and the second part of the clamping device contain a polymer of the same polymer family as the network structure and preferably consist of this polymer.

11. Seat according to one or more of the preceding claims, wherein the seat as a whole or the padding as a whole can be recycled.

12. Method for forming a first part of a clamping device on a padding, the padding comprising
a three-dimensional network structure comprising irregularly bound meshes of one or more continuous linear structures, which continuous linear structures are welded together at crossing points, the continuous linear structures containing at least one thermoplastic elastomer,
characterized in that the first part of the clamping device is shaped, in a thermoforming process, from the material of the three-dimensional network structure using a part of the three-dimensional network structure.

13. Method according to claim 12, wherein the thermoforming of the first part of the clamping device is carried out simultaneously with the formation of filing channels in the padding, preferably in such a way that the first part of the clamping device is located in the filing channels.
